(19) United States
(12) Patent Application Publication
(10) Pub. No.: US 2010/0121681 A1
(43) Pub. Date: May 13, 2010

(54) Method and System of Contextual Advertising

(75) Inventors: Melih Abdulhayoglu, Montclair, NJ (US); Rajiv Gandhi, Valley Cottage, NY (US)

Correspondence Address: Richard Rowley, Suite 1400, 525 Washington Blvd., Jersey City, NJ, 07310, US

(73) Assignee: Comodo CA Limited

(21) Appl. No.: 12/561,027

(22) Filed: Sep. 16, 2009

Related U.S. Application Data
(60) Provisional application No. 61/112,800, filed on Nov. 10, 2008.

(51) Int. Cl. G06Q 30/00; G06Q 10/00; G06F 15/16; G06F 17/30

(52) U.S. Cl. 705/10; 705/14.42; 705/14.53; 705/14.6; 705/14.66; 705/14.69; 709/206; 707/E17.044

(57) ABSTRACT

A method of advertising using a user profile based on a user's interaction with websites, including the time spent on the website and the user's rating of keywords associated with the contents of the website.

### CROSS-REFERENCE TO RELATED APPLICATION

This application claims the benefit of provisional application Ser. No. 61/112,800, filed Nov. 10, 2008, which is incorporated herein by reference.

### BACKGROUND

The Internet has created several new advertising opportunities, including contextual advertising. Advertisers use contextual advertising to directly target products and services to customers who have a known interest in the product or service.

Contextual Advertising depends on a large database of information about the customer. Many websites gather this information by asking website visitors directly about their interests. Submitted information is then stored in a user profile associated with the customer. User profiles can later be refined by the customer logging into the website and modifying their settings.

A large collection of customer information makes mass mailing campaigns easy and cheap. However, consumers ignore mass mail advertising. In addition, mass mailing advertising only targets customers of the site where the information was uploaded. The information entered on one site does not carry over to another website.

Existing advertising methods lack the ability to continually update and narrow customer information to account for changing tastes and unspecified preferences. Few customers make updates to their profiles after the initial data entry. Because most advertisers lack a way to continuously refine their collected information, the information becomes stale quickly.

Techniques attempting to implement an information refinement processes fail to adequately address the problem. For example, popular search engines create a user profile based on the user's search habits. This user profile is refined as the user visits websites retrieved by the search engine. Although search based profiles dynamically update the profile information, the information does not accurately represent the computer user's interests because a computer user may click on website they do not like. In addition, the search engine only gathers information on the websites clicked through the search page. The search engine does not gather information on subsequent pages that may be visited through links or information on pages where the customer enters the URL directly in the browser.

Information storage is an issue with search based profiles as search engines use cookies to track information. Using cookies results in the information not carrying over between computers or browsers, and cookies can be deleted by the customer, often unintentionally.

Current techniques fail to use the information effectively. Besides email campaigns, website operators use profile information to display custom advertising based on the profile on their own website. Likewise, search engines only display custom advertising on the search result pages.

### SUMMARY OF INVENTION

The current invention is a method of creating a user profile that increases the efficiency of online marketing campaigns. The method includes a way of refining a user profile dynamically while the computer user browses websites. The method then uses this dynamically gathered information to create custom content hat is not dependent on the specific website where the information was gathered.

A user profile is created for each computer user. This user profile is refined based on the computer user's interactivity with visited websites. Alternatively, the user profile is created by having the computer user rate tags on the website.

Advertising is displayed based on the information in the user profile. The advertising can depend on the interests and disinterests of the computer user. Advertising can be displayed by software running on the computer or in set locations on subscribing websites. Displaying advertising on websites allows multiple merchants to share the same website advertising space.

The user profile can also be used to display additional information about products and services before the computer user completes an online transaction, allowing competing products and stores to try and grab the computer user's attention at the last minute.

### BRIEF DESCRIPTION OF DRAWINGS

FIG. 1a is a flowchart f how information might be gathered about a computer user.

FIG. 1b is a flowchart f how the information gathered in 1a might be used for advertising.

FIG. 2 is a flowchart of how tags can be used to gather information about computer users.

FIG. 3 is a diagram of the components of FIG. 1.

FIG. 4 is a diagram of FIG. 2.

FIG. 5 is a diagram of how merchants and service providers can provide advertising.

FIG. 6 is a flowchart of an embodiment of the merchant purchase process.

FIG. 7 is a flowchart of continuous advertising.

FIG. 8 is a flowchart of how advertising can be show in response to a user event.

FIG. 9 is a diagram of the process shown in FIG. 8.

### DETAILED DESCRIPTION

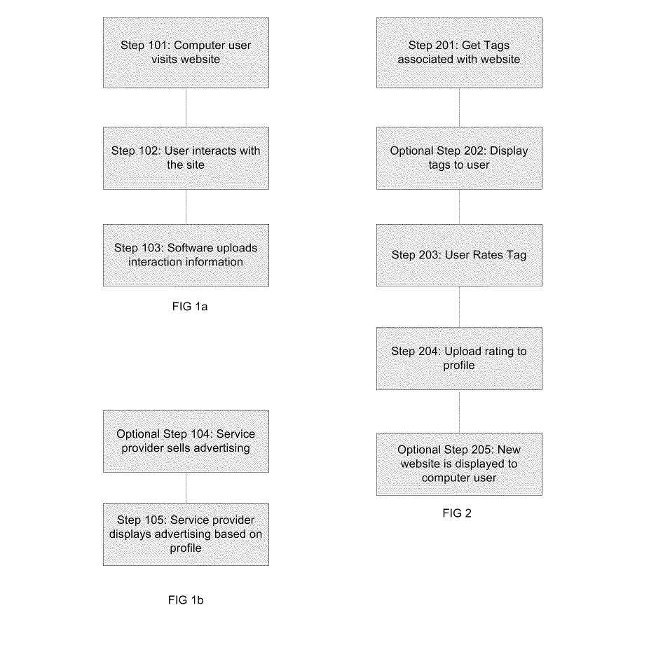

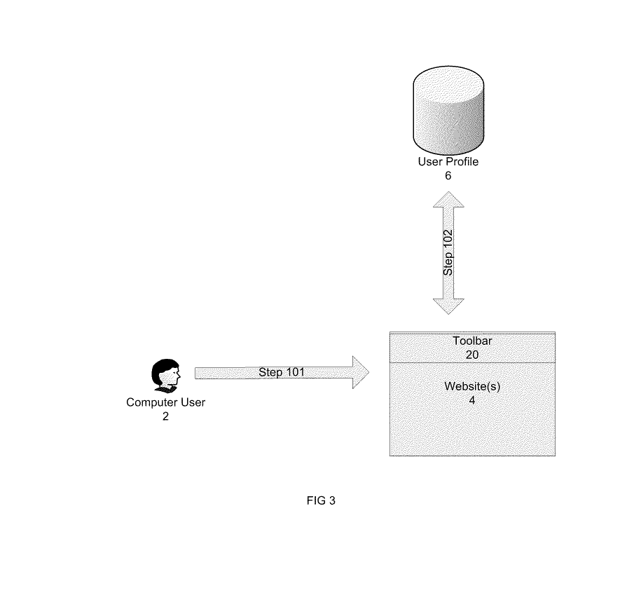

The embodiment in FIG. 1 and FIG. 3 comprises a computer user 2 with a user profile 6 visiting a website 4. In step 102, the computer user 2 interacts with the website 4 by clicking, reading, rating the website, making a review of the website, or taking other actions on the website. In step 103, a toolbar 20 or other software uploads the interactivity to the user profile, resulting in refined information about the computer user 2. A toolbar could be a browser extension of any type, such as an applet running on a frame, a toolbar in the browser, or other software used to communicate with the server storing the user profile.

Instead of recording the specific activity taken by the computer user 2 on the website 4, the user profile 6 can store information on whether the computer user 2 likes or dislikes a site. Whether the computer user 2 likes or dislikes a website 4 can be determined by having the computer user 2 rate the website of by the actions the computer user 2 conducted while on the website 4. For example, if the computer user 2 a) spends a significant amount of time on the website before leaving the website 4, b) clicks a certain number of links on the website, or c) mouses over a certain number of sections on the website, the user profile 6 stores that the computer user 2 liked or is positive towards the website 4. Alternatively, if the computer user 2 closed the website under a certain amount of time, the user profile 6 stores the computer user 2 as disliking or being negative towards the website 4.

Rather than storing website specific information having, the user profile could contain information of a more general nature. If the computer user 2 is positive about a website 4 displaying sports information, the user profile would store the positive data about sports rather than the specific website visited.

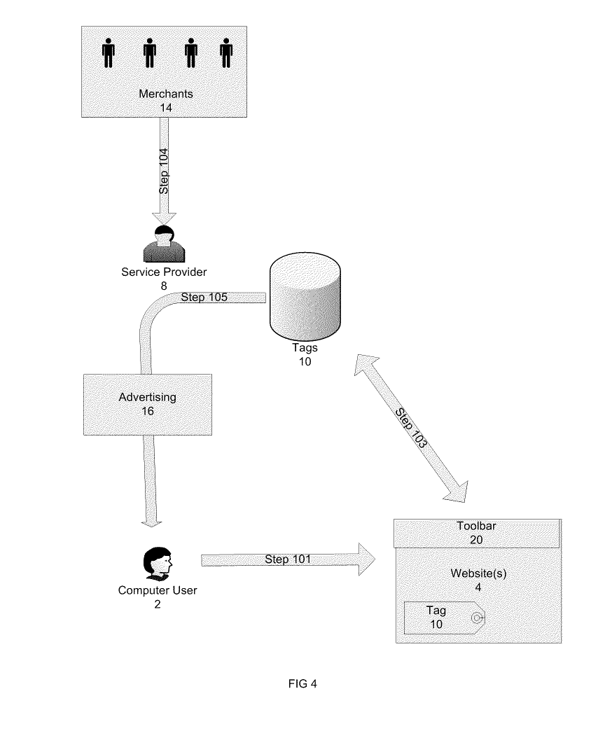

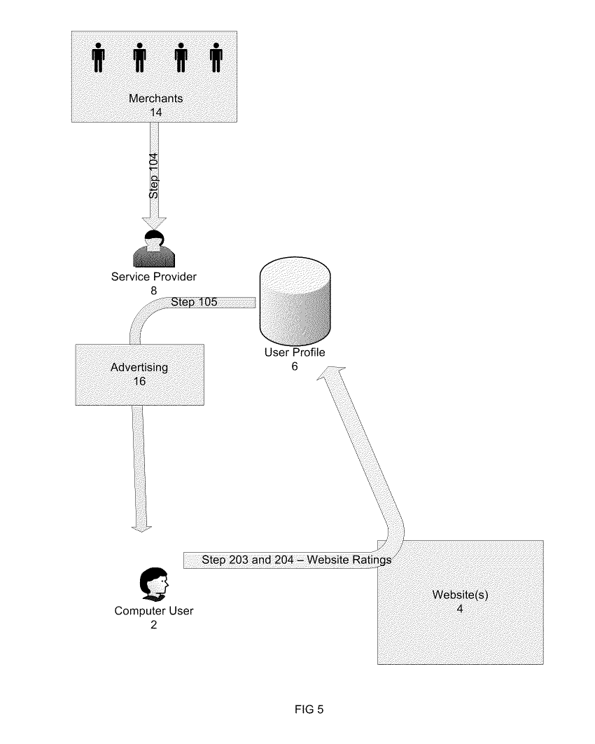

An alternate way of refining the user profile 6 is shown in FIG. 2 and FIG. 4. In Step 201, information about the contents of a website is retrieved. This information can be in the form of “tags” 12 which are keywords about the contents or information displayed on the website. Tags can be a keyword, picture, or other bit of information associated with the contents of the website or the contents of part of the website. These tags can be stored on the website 4 itself or in a tag database 10. The tags 12 are created by a) the computer user 2 manually enter the tag 12 into the tag database 10 through a toolbar, a frame, or through the website of a service provider 8, b) the service provider 8 creating a tag or set of tags for each website 4, c) automatically assigning tags based on the meta-data of the website 4, or d) the website owner uploading tags to the database. Of course, a combination of any of these methods can be used. Optionally, the tags 12 created by one computer user 2 are available to all additional computer users. In optional Step 202, the tags 12 about the website 4 contents are displayed to the computer user 2. Whether tags 12 are displayed or hidden from the computer user 2 can depend on information already stored in the user profile 6. For example, if a computer user 2 likes sports and the tag 10 is associated with sports, the tag 12 will be displayed to the computer user 2. If the user profile 6 does not contain any information about the computer user's 2 interest in sports, the tag 12 will be hidden.

In step 204, the tags 12 are rated by the computer user 2 to refine information stored in the user profile 6. In step 204, this rating updates the user profile 6. A rating can be set by the computer user 2 or automatically assigned to the tag 12 based on how often the computer user 2 visits the website 4 or the amount of activity the computer user 2 has on the website 4. If the computer user 2 visits the website 4 frequently or spends longer interacting with the website, then the website 4 is more popular with that computer user 2 and a higher rating is stored in the user profile 6 for that tag 12.

The computer user 2 can rate the website 4 and/or related tags 12 using any known mechanism such as a number scale, a star rating, a “thumbs-up” system, or a letter grade. To quickly gather ratings, the computer user 2 could be presented with a series of successive websites for rating. Regardless of how the ratings are captured, adding the computer user's 2 tag rating to the user profile 6 lets the service provider 8 know how much the computer user 2 likes the contents of a particular website 4. This also lets the service provider 8 know how much the computer user 2 likes the categories of the tags 12 on the website 4. This tag information is invaluable marketing information as it can be used to directly market products and services associated with highly rated tags.

In optional step 205, a new website is displayed to the computer user after the rating information is collected. The automatic display of a new website keeps the computer user using the rating system and continues to refine the user profile.

Often, websites contain information on several related or unrelated topics. Some of these topics might be of interest to the computer user while others are of less interest. For example, a sports site could contain news on both baseball and football. A computer user might like football but be indifferent towards baseball. A single rating for the entire website is misleading as the rating does not accurately reflect the computer user's true interests. This limitation can be overcome by (a) monitoring how the computer user 2 interacts with the website 4, (b) collecting ratings on different websites until enough ratings exist to identify which part of the website was interesting to the computer user, or (c) having the computer user 2 rate or enter tags 12 individually for each part of the website.

Method (a) above, the user profile 6 can accurately be built using information about the time spent on various sub-websites, information about how long the computer user spends on the website, and/or information about where the computer user's mouse hovers or clicks. If a computer user 2 interacts heavily with a sports related site, but only with the football related content, the user profile 6 would store that the computer user 2 likes football but is less positive towards other sports.

Method (b) requires several website ratings. With enough website ratings, the average rating of a tag 12 associated with a website 4 becomes an accurate representation of the computer user's 2 interests and disinterests.

To prevent mistakes from entering the user profile 6, the user profile 6 can require a certain threshold of information before a tag or particular content is rated as being liked or disliked. The computer user can also be granted access to the profile to manually change and set their interest level. If a set number of positive ratings are received on a tag 12 or website 4 then the tag 12 or website 4 may be added automatically as a strong interest or hobby of the use, and vice versa.

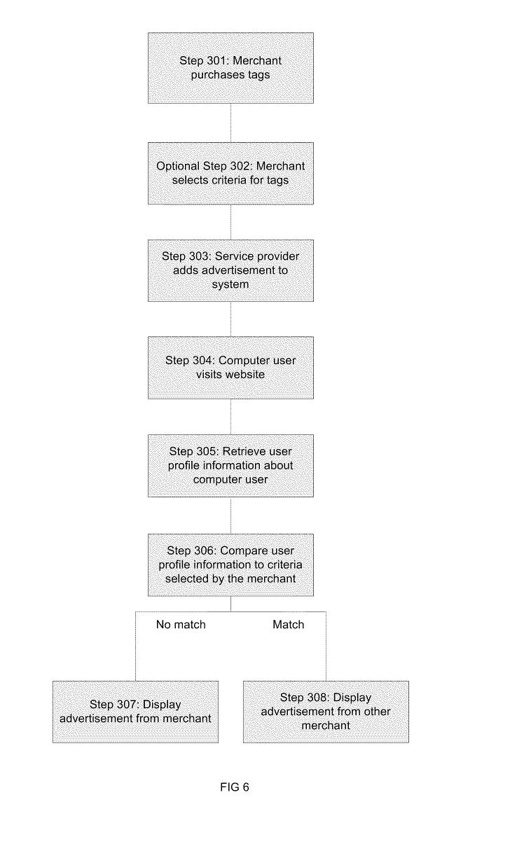

In step 104, shown in FIG. 1b and FIG. 5, the service provider 8 uses the user profile 6 to assist merchants 14 in marketing campaigns targeted towards computer users 2 with specific interests or disinterests. In step 105, banners, email campaigns, pop-ups, and other types of advertising material 16 are customized to target only computer users 2 that meet certain interest criteria as determined by their user profile 6. Computer users 2 are filtered based on their interest, disinterest, or indifference towards a particular tag, keyword, and/or website (depending on the information in the user profile). Advertising does not need to be actual product or service promotions, but could be information of a general nature. Advertising is any information displayed to the computer user based on the information in the user profile.

Merchants 14 can submit advertising material 16 to be displayed to computer users 2 matching any of the criteria in the user profile 6, or the service provider can sell merchants 14 information associated with a particular set of tags 12 (or just one tag). If a service provider 8 is operating the advertising campaign, the service provider can contract with website owners to display the advertising in banner on each website. The advertisement 16 displayed by the service provider 8 would depend on the merchant 14 purchasing the tag and the computer user's 2 rating of that tag. The service provider 8 would interact with the toolbar 20 to get the user profile 6 of the computer user 2 and serve the advertising 16 to the website 4 being visited.

Of course, a merchant 14 could perform the entire method directly without using a service provider 8. Eliminating the role of the service provider 8 is useful for big companies that sell a variety of merchandise and want each computer user to have a customized experience when visiting the merchant's website.

Every party benefits from the arrangement. The computer user 2 is only presented with advertising 16 that is of interest to them, limiting the amount of irrelevant information. The merchant 14 increases their revenue using targeted marketing and lowers their per customer advertising cost. A website owner displaying the advertising (if different than the merchant) sells more advertising options with taking up additional website real estate. The service provider 8 sells more website advertising space on popular websites. The service provider 8 can also increase its profits by selling high-cost advertising for popular tags 12. Many companies are willing to pay a higher premium for popular tags. Smaller companies are able to purchase less popular tags for cheaper, saving them money without necessarily hurting their advertising.

For example, a merchant 4 can buy advertising 16 on a website 4 that will only display to computer users 2 that have football as an interest in their user profile 6. The same advertising space on the website 4 can also be sold to a merchant 4 interested in buying the “baseball” tag 12. The advertisement 16 will display in the same spot on the website 4, but the actual content of the advertisement will vary depending on the user profile 6 of the computer user 2. Of course, an advertisement 16 does not need to be displayed on the website to be effective. This information can also be used to display a popup associated with a website or can be used for directed email solicitations. Interest categories and specific website ratings can be purchased instead of tags.

In another example, a first merchant purchases the interest category of football. A second merchant purchases advertising to for users with a high rating of in cars, and a third advertiser purchases advertising for computer users with a low rating for religion. When a computer user 2 is visiting a website 4, the merchant(s) 14 whose advertisement 16 will be displayed depends on the user profile 6. A first computer user might see the third merchant's advertisement, while a second computer user might see both the first and second merchant's advertisements. Billing for each of advertisement can be arranged on a “per serve” basis, allowing the merchants to only pay for each user seeing their ad.

A merchant 4 can tailor their advertising 16 to appeal to computer users with certain disinterests. For example, a human rights group could purchase advertising to show to computer users with a dislike of consumer product testing on animals. The human rights advertisement would then appear on the website each time a computer user with this particular dislike visits the website.

Another example is a politician desiring to run two different campaign ads: one targeting individuals already interested in his campaign and a second targeting computer users who are disinterested in his competitor (but not necessarily interested in the politician himself). The politician can purchase and display two separate ads: one for those with a like of the politician and one with a dislike in his opponent. The politician can even go a step further and prepare specific ads for each campaign so that the appropriate message is conveyed.

The interests and disinterests can be sold separately or together to create even more direct customized advertising. For example, a merchant 14 can purchase advertising that will only display to computer users who have a like of cars, alcohol and sports. Other merchants could then advertise to computer users who like alcohol and sports but dislike alcohol.

FIG. 6 shows an embodiment of how the advertising sales would work. In step 301, the merchant 14 selects which tags 12 he wants to market towards. In optional step 302, the merchant may select a minimum threshold of interest or disinterest that must be in the user profile 6 before the advertisement 16 appears. The merchant 14 also supplies the advertisement(s) he wants displayed for each tag 12 or a combination of tags. Alternatively, the service provider 8 can provide the advertisement 16. In step 303, the service provider 8 puts the advertisement onto their advertising system. When a computer user 2 visits the website in step 304, the toolbar 20 communicates with the service provider's systems to retrieve the user profile 6. The service provider's systems return the user advertising 16 based on the information in the user profile 6 (step 306) and displays the advertisement 16 to the computer user 2.

Merchants can use and purchase well-known or predefined words and tags or create their own tags. This way the merchant 14 is not limited to the service provider's 8 predefined set of tags 12 and can expand the tag database 10. Newly created tags are automatically included as part of the toolbar 20 and applied to websites matching the tag, whether by examining the meta-data associated with each website, having users select the tag as appropriate for the website, or some other means. Computer users can then rate the websites using the newly created tags.

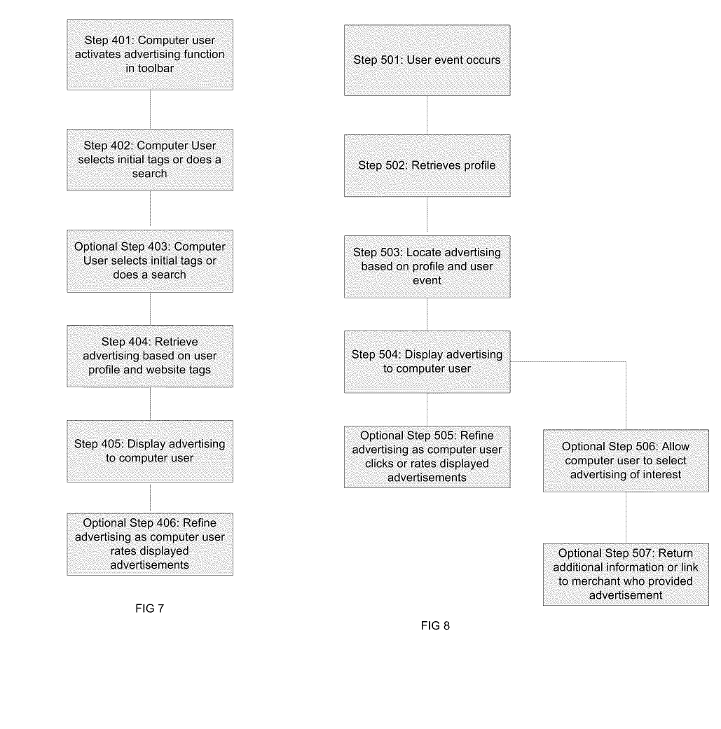

In a separate embodiment shown in FIGS. 7 and 9, the computer user 2 activates an advertising function through a toolbar 20 while shopping or looking for information on the Internet (step 401). Once the computer user 2 activates the advertising function, the computer user 2 can enter or select tags 10 to create a search (step 402). If the computer user 2 does not know what they are looking for, the toolbar can select a product or website for the computer based on the interests stored in the user profile 6. The products and services can be displayed as if they were search results allowing multiple website links to be displayed and then having the computer user select which one they are interested in. In step 405, advertising 16 is retrieved from the service provider 8 based on the user profile 6. In optional step 406, the computer user 2 rates the advertising 16. After rating the advertisement 16, the service provider's 8 systems analyze the new rating in connection with the user profile 6 and present additional, modified advertising to the computer user 2. This allows the computer user 2 to hone in on exactly what product or service they are looking for.

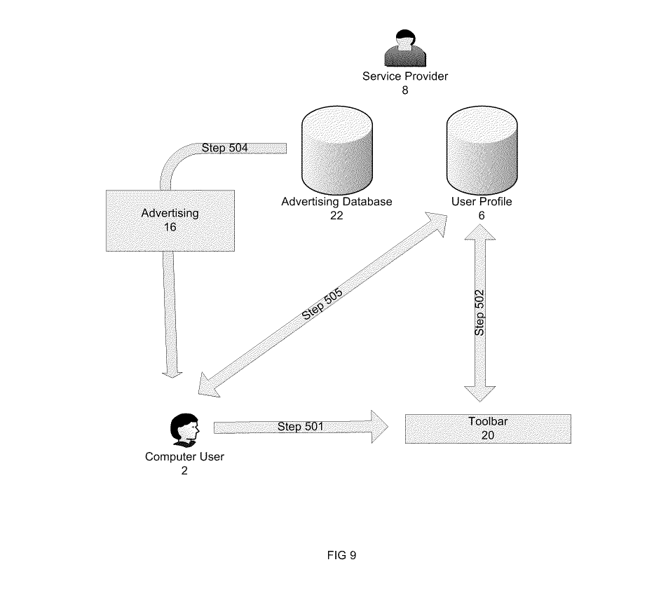

An alternate embodiment shown in FIG. 8 displays advertising upon the occurrence of a user event, such as when the computer user clicks a certain part of the website, enters text in a field, or inputs a credit card number. The advertising 17 is then displayed to the computer user. This provides advertising at crucial moments, such as when the computer user 2 requests information or when the computer user 2 takes a certain action. For example, the toolbar 20 can retrieve additional information whenever a shopping cart is clicked to give the computer user 2 more information about a selected product or to offer the computer user additional choices of stores or products and services.

Instead of having the advertising material displayed automatically, the computer user could activate the advertising function by clicking a button in the toolbar. Advertising for products and services similar to the one displayed on the current website would be displayed. For example, if the computer user likes a certain brand of security product but dislikes other brands, the user can click the toolbar after making a search for antivirus products or visiting a website about antivirus products to find out that particular brand offers an antivirus product.

The toolbar 20 can also be used to display a website 4 of a merchant 16 that corresponds to the user profile 6 when the browser is first activated or loaded. This presents the computer user with a new and interesting browsing experience every time the access the Internet as the page can be random based on the interests of the computer user.

An extension of the embodiment in FIG. 8 has the computer user 2 select which products displayed interest him (step 506). In step 507, the toolbar 20 sends the merchant 14 purchasing the advertisement 17 the computer user's information. The merchant 14 can contact the computer user or send the computer user a message to initiate a relationship. The toolbar could have a chat feature built in to allow the merchant 14 to communicate directly with the computer user 2 while browsing the website. By clicking the toolbar, a chat session would be initiated with the merchant who purchased the advertising.

In addition to contacting the merchant, the toolbar 20 could also retrieve more information about the selected products. This information could be sent by the merchant in response to each query received or from a separate database. This information might be having the browser navigate to a new website that has information about the selected products and services.

An alternate embodiment allows the computer user to select a tag to see additional information. Once the tag is selected, a list of advertisers or advertisements associated with the tag would be displayed. The tags displayed can be limited to only those of interest to the computer user, preventing too many tags from appearing on a single website. The tags can be displayed over the part of the webpage associate with the tag or can be displayed in the toolbar installed by the user.

For example, several products or services might fit the profile of a computer user. When the computer user searches or browses a website, the toolbar presents the tags to the computer user. The computer user clicks the tag and the merchant(s) who paid for that tag would have their advertisement displayed. This allows several merchants to present their products in the same advertising space to various computer users. The tag/keyword is used to display the ad and link the ad back to the site of the merchant.

The invention is not restricted to the details of the foregoing embodiments. The invention extend to any novel one, or any novel combination, of the features disclosed in this specification (including any accompanying claims, abstract and drawings), or to any novel one, or any novel combination, of the steps of any method or process so disclosed.

What is claimed is:

1. A method of updating a user profile, comprising rating a tag associated with the contents of a website and uploading the rating to the user profile.

2. A method according to claim 1, where the rating of a tag is a rating provided by the computer user.

3. A method according to claim 1, where the rating is the number of visits the computer user makes to websites with similar tags.

4. A method according to claim 1, where the rating is the determined based on the interactivity of the computer user with the website.

5. A method according to claim 1, where the interactivity is the amount of time the user spends on a website.

6. A method according to claim 5, where the interactivity is the amount of time the user spends on a part of the website associated with the tag.

7. A method according to claim 6 where the interactivity is the user clicking part of the website.

8. A method according to claim 1, further comprising adding a tag that receives a positive rating to a list of a computer user's interests.

9. A method according to claim 1, further comprising adding a tag that receives a negative rating to a list of a computer user's disinterests.

10. A method according to claim 1, where the tag is determined by the meta-data associated with the website.

11. A method according to claim 1, where the tag is created from by a computer user while browsing the website.

12. A method according to claim 1, where the tag is created by a service provider that operates a database storing the user profile.

13. A method according to claim 1, where a tag is only displayed if it relates to information already in the user profile.

14. A method according to claim 1, where a new website is displayed to the computer user after the tag is rated.

15. A method according to claim 1, where the tag is associated with only part of the website.

16. A method according to claim 1, that further comprises multiple tags with each tag being associated with part of the website.

17. A method of advertising comprising:
Having a computer user browse to a website,
Retrieving information about the computer user,
Retrieving information about the contents of the website, and
Displaying advertising customized for the computer user at a location on the website selected by the website's operator.

18. A method according to claim 17 where the advertising is based on the computer user's interests.

19. A method according to claim 17 where the advertising is based on the computer user's disinterests.

20. A method according to claim 17 where a first advertisement from a merchant is displayed if the computer user has an interest in the website contents and a second advertisement from the same merchant is displayed if the computer user has a disinterest in the website contents.

21. A method of advertising to computer users comprising:
Gathering information about computer users;
Having merchants purchase certain tags;
Having a computer user visit a website; and
Displaying advertising from a merchant based on a purchased tag and based on information gathered about the computer user visiting the site.

22. A method according to claim 21, where the advertising is displayed if the computer user has positively rated the tag purchased by the merchant.

23. A method according to claim 21, where the advertising is displayed if the computer user has negatively rated the tag purchased by the merchant.

24. A method according to claim 21, where the information is a rating of the tags associated with a website and a different advertisement is displayed for a computer user with a positive rating of a tag than a computer user with a negative rating of the same tag.

25. A method according to claim 21, where the information is a rating of a tag associated with a website and a first merchant's advertisement is displayed to computer users with a positive rating of a tag and second merchant's advertisement is displayed to computer users with a negative rating of a tag.

26. A method of searching the Internet comprising having a computer user select a tag on the website currently being visited and displaying a list of merchants associated with the selected tag.

27. A method according to claim 26 further comprising only displaying the tag on the website if the tag relates to information stored in a user profile that is associated with the user.

28. A method of searching the Internet comprising:
Gathering information about a computer user,
Having websites associated with keywords that describe the contents, and
Displaying a website to the computer user based on the information gathered about the computer user and the keywords associated with the website.

29. The method in claim 28, further comprising having the computer user associate keywords with websites while browsing the Internet.

30. The method in claim 28, where the website displayed is further dependent on a text string entered by the computer user.

31. The method in claim 28, where the computer user may rate the displayed website and a new website is displayed based on the rating by the computer user.

32. The method in claim 28, where the website is displayed when a browser is first stated.

33. A method of communication comprising:
Gathering information about a computer user,
Displaying advertising based on the information gathered about the computer user,
Sending a message to the computer user about the contents of the advertisement.

34. A method of according to claim 33, where the message is a chat message initiated by a merchant.

35. A method of according to claim 33, where the message is an email message from an entity associated with the advertisement.

36. A method of according to claim 33, where the message is additional information about a product or service shown in the advisement.

37. A system of advertising comprising:
A computer user;
A database;
A rating system;
A website;
Means for creating a user profile with information about a computer user, and
Means for displaying advertisements based on the user profile.

38. A system according to claim 37, where the user profile comprises information on the user's disinterests.

39. A system according to claim 37, further comprising keywords associated with the website.

40. A system according to claim 39, where the advertising selection comprises of comparing the keywords to information found in the user profile.
